(19) United States
(12) Patent Application Publication
(10) Pub. No.: US 2011/0154261 A1
(43) Pub. Date: Jun. 23, 2011

(54) USER INTERFACE WITH RIBBON USAGE FOR HEARING AID FITTING SYSTEMS

(75) Inventors: Daniel Mark Edgar, Lakeville, MN (US); J. Virgil Bradley, Plymouth, MN (US)

(73) Assignee: Starkey Laboratories, Inc., Eden Prairie, MN (US)

(21) Appl. No.: 12/643,754

(22) Filed: Dec. 21, 2009

(51) Int. Cl. G06F 3/048

(52) U.S. Cl. 715/825; 715/843

(57) ABSTRACT

The present subject matter relates generally to an improved user interface for input and output of information used in fitting systems for hearing aids. In an embodiment the system includes displaying, on a display device, a graphical user interface, wherein the graphical user interface includes a ribbon showing one or more functional category associated with fitting the hearing aid to the wearer, the graphical user interface adapted to display response data of the hearing aid according to data inputted into the one or more functional categories, wherein the data inputted comprises settings data for the one or more functional categories. The system further includes updating the data displayed on the display device in response to receiving changed data inputted into the one or more functional categories of the ribbon.

### FIELD OF THE INVENTION

The present subject matter relates generally to an improved user interface for input and output of information used in fitting systems for hearing aids, and in particular to a user interface using ribbons for hearing aid fitting systems.

### BACKGROUND

Wearers of hearing aids undergo a process called “fitting” to adjust the hearing aid to their particular hearing and use. In such fitting sessions the wearer may select one setting over another, much like selecting one setting over another in an eye test. Other types of selections include changes in level, which can be a preferred level. A hearing aid fitting session may involve several attempts at fitting the aids or may be uneventful.

The process of fitting a hearing aid can involve the selection of several parameters. Software for performing the fitting can have several menus and can serve to be a tedious and complicated data entry task for the clinician or audiologist. Thus, there is a need in the art for improved data access and entry for hearing aid fitting systems.

### SUMMARY

Disclosed herein, among other things, is an improved user interface for input and output of information used in fitting systems for hearing aids, and in particular to a user interface using ribbons for hearing aid fitting systems. In various embodiments, dynamic buttons on the ribbon are used to show past or present setting information. In various embodiments, the dynamic buttons are adapted to depict graphical information associated with settings of the hearing aid, audiogram information, or other graphical depictions of the settings.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 shows a hearing aid fitting system, according to one embodiment of the present subject matter.

FIGS. 2-4 show ribbon user interfaces according to various embodiments of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The present subject matter includes an improved user interface for input and output of information used in fitting systems for hearing aids, and in particular to a user interface using ribbons for hearing aid fitting systems. A ribbon is a programming concept introduced in products such as Microsoft's Office 2007. The introduction of the ribbon provides one or more of the following: live preview of an action before it is taken via Gallery functionality, elimination of dialogs to perform major operations, categorization of major functions into functional areas—(e.g., Home, Insert, Page Layout, Review, View), and an increase in data density to allow “all in one views” of major functional areas. These ribbon concepts greatly enhance workflow and presentation of data in a fitting system for hearing aids. Further examples of ribbon style guidelines and gallery features can be found in the “2007 Office System Document: UI Style Guide for Solutions and Add Ins” dated May of 2006, the entirety of which is incorporated by reference.

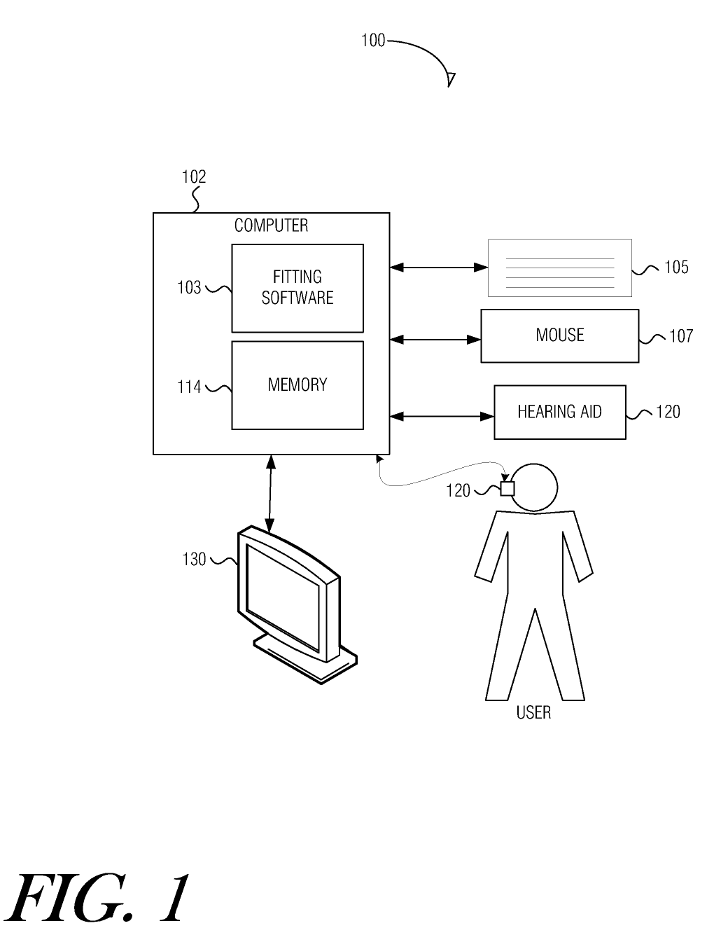

FIG. 1 shows an example fitting system. Computer 102 is adapted to execute fitting software 103 that takes typical inputs from devices such as keyboard 105 and mouse 107 for fitting one or more hearing aids 120. It is understood that the user may be the wearer of one or more hearing aids or there can be a clinician, audiologist or other attendant assisting with the use of the fitting system 110. The system 100 includes memory 114 which stores and displays on display 130 one or more user interfaces for the fitting system. It is understood that the configuration shown in FIG. 1 is demonstrative and is not intended in an exhaustive or exclusive sense. Other configurations may exist without departing from the scope of the present subject matter. For example, it is possible that the memory 114 may be encoded in firmware, software, or combinations thereof. It is possible that the system may omit a mouse or a keyboard or may include additional input/output devices without departing from the scope of the present subject matter. For example, a user may use the display as the input device (e.g., a resistive or capacitive touch screen). One or more circuits may be included in the computer 102 to implement the functionality of the embodiments described herein. For example, an input circuit may receive input data from one or more user interfaces and an output circuit may display the graphical user interface on a display device as well as output response data.

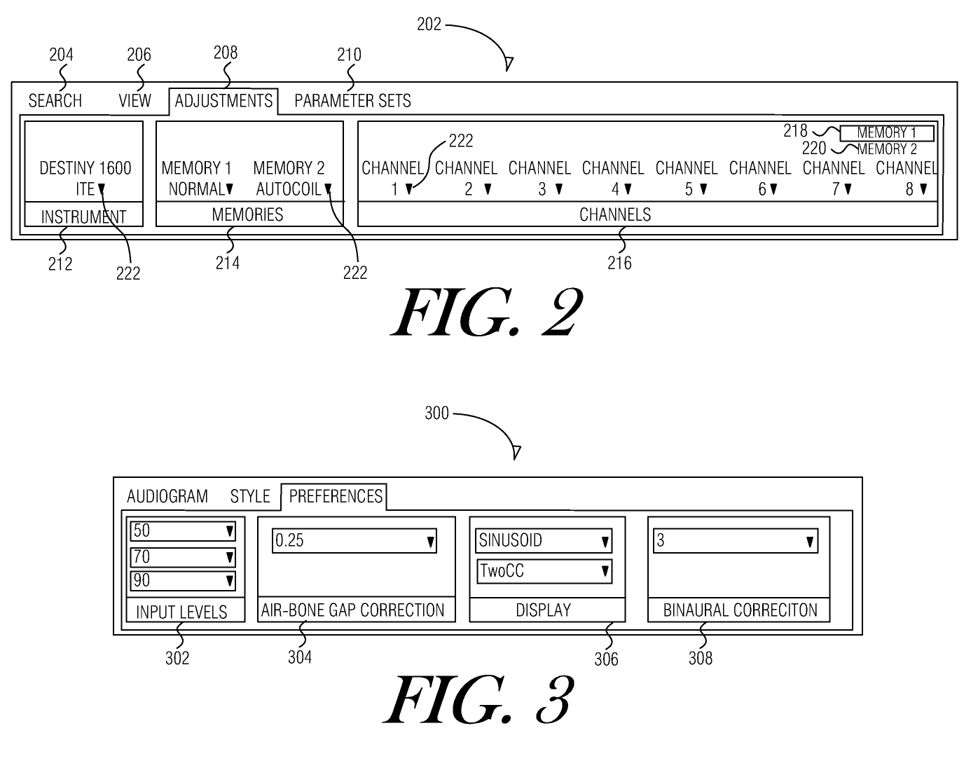

In an example embodiment, the fitting software uses a ribbon interface. FIG. 2 illustrates an example ribbon user interface according to one example of the present subject matter. FIG. 2 has ribbon interface 202 with four functional categories: Search category 204, View category 206, Adjustments category 208, and Parameter Sets 210. Adjustments category 208 includes three sub-sections: Instrument section 212, Memories section 214, and Channels section 216. The view on interface 202 allows a user to encompass a full instrument status summary.

Not illustrated is additional settings data that could be shown in the ribbon interface. For example, Instrument section 212 lists the device “Destiny 1600 ITE.” In various embodiments, above the device name a picture of the device is shown. Above “Memory 1” in Memories section 214 a visual of the memory status is displayed (e.g., enabled, disabled, environment, tones). Above “Channel 1” in Channels section 216 a representation of the compression ration in that channel is displayed.

Further illustrated in FIG. 2 are memory selectors 218 and 220. There are individual channels per memory. Thus, when a user clicks on memory selector 218 or 220, the channels for that respective channel will be shown in Channels section 216. In FIG. 2, memory selector 218, “Memory 1,” is selected and Channels 1-8 are shown in Channels section 216.

In various embodiments the elements illustrated in interface 202 provide users with drop down menus (e.g., element 222) that show all adjustment that can be made to the functional part of the hearing aid. For example, clicking on the “Channel 1” element will show a list of adjustments that can be made for Channel 1 of memory 1. In an embodiment, slider adjustments for “Memory 1” are custom patient, per memory hearing aid response adjustments. Adjustments for the “Destiny 1600 ITE” include one or more of the following: battery beep tone levels, telephone beep tone levels, and voice language. Adjustments for “Memory 1 Normal” include one or more of the following: virtual volume control, feedback cancellation, gain reduction, and band adjustments. Additional adjustments for each element may be added without departing from the present subject matter. In various embodiments the drop down menus are implemented as dynamic buttons allowing a user to see past settings for each of the categories. In various embodiments, dynamic buttons on the ribbon are used to show past or present setting information. In various embodiments, the dynamic buttons are adapted to depict graphical information associated with settings of the hearing aid, audiogram information, or other graphical depictions of the settings.

In various embodiments, the use of a ribbon interface helps to solve problems that exist within current fitting software such as organizing adjustments without navigating to multiple screens and providing an overview status of the entire hearing aid including response status or response data. In various embodiments the response data includes diagnostic details and response curves of a hearing aid (e.g., as a function of frequency). Using a ribbon interface in an audiological system allows a user uninterrupted flow to many core functions that a user currently has to interrupt the fitting flow to navigate to. In various embodiments the ribbon may be customized by adding, removing, or moving settings depicted on a ribbon interface.

In an embodiment, memory operations are done using a “memory operations” tab on a ribbon interface. The memory operations allow memories to be moved, copied, and linked. The operations are done without leaving the memory operations tab and the tab allows adjustments to be made to the response.

In various embodiments, a ribbon interface in an audiological fitting system enables modeling and response operations to occur in the main work area without interrupting the workflow for operations not related to the modeling and response. The main work area may serve other functions of a fitting system beyond displaying information of hearing aid responses. In various embodiments, these functions include activation of media playback, use of expert assistant, roll up of target display/modification, and real time functions like speech mapping.

In, various embodiments, the ribbon interface is located in different positions relative to the work area. For example, the ribbon interface may be located above, left, right, or below the main work area. In another embodiment, the ribbon is a free standing floating window movable by a user's input (e.g., touch or mouse).

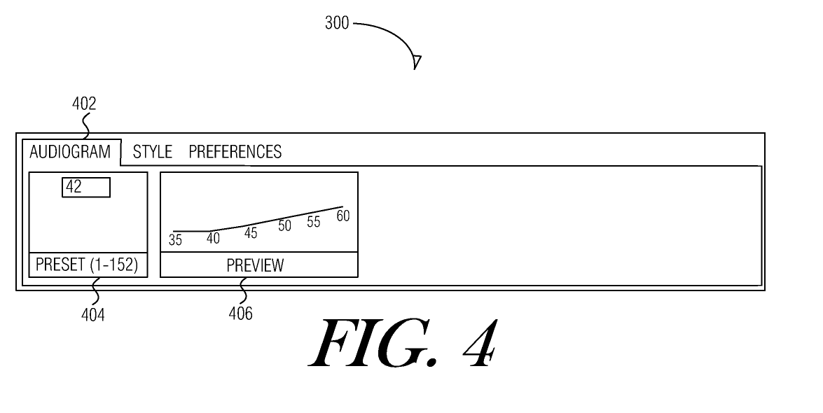

In various embodiments, preferences associated with the fitting system are available in a tab in the ribbon interface. Providing the preferences on the ribbon allows a user a seamless way to edit preferences without interrupting the flow of the overall fitting system FIG. 3 illustrates an example preferences tab 300 in a ribbon interface according to the present subject matter. Diagramed are input levels 302, air-bone gap correction 304, display 306, and binaural correction 308. Other preferences may be added or subtracted from preferences tab 300 without departing from the scope of the present subject matter. The use of tabbed preferences puts the user in control of editing preferences inline without the user of extra dialog boxes.

FIG. 4 diagrams ribbon interface 300, audiogram tab 402, preset section 404, and preview section 406. In various embodiments, preview section 406 is a dynamic button. The patient audiogram serves as a core variable for all fitting system operations that an audiologist may take. However, having the audiogram of the patient always visible and usable has been a problem to work into a fitting system. Using ribbon interface 300 enables audiogram management to be readily visible. In a simple audiogram ribbon, such as audiogram section 402, new audiogram presets are illustrated in preset section 404 with the audiogram curve in preview section 406. A full audiogram editor can be put within the ribbon to see more than just the air conduction curves, but other audiogram curves as well. such as the following: uncomfortable level (UCL) indicating the dB HL measure of a specific pure tone playback that the patient deems uncomfortable, bone conduction level (BCL) indicating the dB HL measure using specialized playback through the bones of the skull of when a patient can hear playback of a specific pure tone, and air conduction level (ACL) indicating the dB HL measure when a patient can hear playback of a specific pure tone through headphones using air to conduct the sound.

In various embodiments, third party software can be used to generate interfaces, including, but not limited to the Infragistics NetAdvantage for Windows Presentation Foundation xamRibbon component. Other third party software can be used without departing from the scope of the present subject matter.

The present subject matter is demonstrated in the fitting of hearing aids, including but not limited to, behind-the-ear (BTE), in-the-ear (ITE), in-the-canal (ITC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user. The present subject matter can also be used in hearing assistance devices generally, such as cochlear implant type hearing devices. It is understood that other hearing assistance devices not expressly stated herein may be used in conjunction with the present subject matter.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A fitting system for fitting a hearing aid to a wearer, comprising:
a display device;
a processor to execute instructions which are adapted to provide a graphical user interface on the display device, the graphical user interface includes a ribbon showing one or more functional categories associated with fitting the hearing aid to the wearer, the graphical user interface adapted to display response data of the hearing aid according to data inputted into the one or more functional categories, wherein the data inputted comprises settings data for the one or more functional categories, and
wherein the data displayed on the display device changes in response to changed data inputted into the one or more functional categories.

2. The fitting system of claim 1, wherein the one or more functional categories comprises a plurality of dynamic buttons.

3. The fitting system of claim 2, wherein the plurality of dynamic buttons comprise drop down menus showing one or more past input data settings.

4. The fitting system of claim 1, wherein the ribbon shows an adjustments category, wherein the adjustments category comprises instrument settings, memories settings, and channel settings.

5. The fitting system of claim 4, wherein the instrument settings comprises a drop down menu of one or more hearing aids.

6. The fitting system of claim 1, wherein the ribbon shows a preferences category.

7. The fitting system of claim 1, wherein the graphical user interface is adapted to receive input data to customize the ribbon.

8. The fitting system of claim 1, wherein the ribbon shows an audiogram category, wherein the audiogram category comprises a preview graph of an audiogram.

9. A method for fitting a hearing to a wearer comprising:
displaying, on a display device, a graphical user interface, wherein the graphical user interface includes a ribbon showing one or more functional categories associated with fitting the hearing aid to the wearer, the graphical user interface adapted to display response data of the hearing aid according to data inputted into the one or more functional categories, wherein the data inputted comprises settings data for the one or more functional categories; and
updating the data displayed on the display device in response to changes of the data inputted into the one or more functional categories of the ribbon.

10. The method of claim 9, wherein displaying the graphical user interface comprises:
displaying a plurality of dynamic buttons of the one or more functional categories.

11. The method of claim 10, wherein displaying a plurality of dynamic buttons of the one or more functional categories comprises:
displaying past drop down menus showing one or more past input data settings.

12. The method of claim 9, wherein displaying the graphical user interface comprises:
displaying an adjustments category, wherein the adjustments category comprise instrument settings, memories settings, and channel settings.

13. The method of claim 12, wherein displaying an adjustments category comprises:
displaying a drop down menu of one or more hearing aids.

14. The method of claim 9, wherein displaying the graphical user interface comprises:
displaying a preferences category.

15. The method of claim 9, further comprising:
receiving input data to customize the ribbon.

16. The method of claim 9, wherein displaying the graphical user interface comprises:
displaying an audiogram category, wherein the audiogram category comprises a preview graph of an audiogram.
